(19) United States
(12) Patent Application Publication
(10) Pub. No.: US 2003/0058567 A1
(43) Pub. Date: Mar. 27, 2003

(54) Intelligent disk drive

(76) Inventor: Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/963,729

(22) Filed: Sep. 26, 2001

(51) Int. Cl. G11B 15/18; G11B 17/00; G11B 19/02; G06F 15/18; G06F 15/00; G11B 21/08; G11B 7/085; G06F 3/00; G06F 15/177; G06F 9/445; G06F 9/24; G06F 9/00

(52) U.S. Cl. 360/71; 369/30.27; 710/5; 713/2

(57) ABSTRACT

The present disclosure relates to an intelligent disk drive. In one arrangement, the disk drive is configured to be operated by detecting insertion of a disk within the disk drive, reading contents of the disk, and storing a copy of the disk contents in a designated location within memory as a back-up version. In another arrangement, the disk drive is configured to be operated by detecting a shut down procedure of the computing device, and transmitting an ejection command to the disk drive to cause an ejection mechanism of the disk drive to actuate to eject a floppy disk inserted within the disk drive.

### FIELD OF THE INVENTION

The present disclosure relates to a disk drive. More particularly, the disclosure relates to an intelligent disk drive that is configured to automatically back-up disk contents and automatically eject the disk upon shut down.

### BACKGROUND OF THE INVENTION

Many computing devices, such as personal computers (PCs), include floppy disk drives that are adapted to receive floppy disks such as 5.25 inch and 3.5 inch floppy disks. Despite the rising popularity of transmitting data from place to place via a network (e.g., over the Internet), disk drives are still desired by most computing device users.

Although floppy disk drives have been in existence for many years, various problems with their use still remain. To cite one example, floppy disk drives can delay booting of a computing device where a non-system disk is left in the drive during the boot-up procedure. This often occurs when the user inadvertently leaves the disk in the drive and later attempts to boot or restart the computing device. In such cases, the user may initiate the booting or restart procedure, leave the computing device to give it time to perform the desired procedure, and return to the device only to discover that the procedure was interrupted in an early stage of its completion. This occurs because computing devices regard floppy disks as non-system disks. To remedy the problem, the user must remove the disk and reinitiate the booting or restart procedure by selecting a resume command. Such an experience can both waste time and frustrate the user.

Another frequently encountered problem relates to accessing the source of data after a floppy disk has been removed from its drive. If, for instance, the user accesses a particular file stored on a floppy disk, modifies the file in some way in a user application (e.g., word processing application), and later attempts to access the source of the data to perform some desired task (e.g., store a new version of the file), the computing device will discover that the disk is not in the drive and will either display an error message or lock up. This occurs because the absence of the disk causes the system to stop responding and can result in a system error. Where the error message has been received, the user must locate the correct disk, reinsert it in the disk drive, and attempt to remove the error message, which often requires repeated entry of an “escape” command. Where the computing device has locked up due to the absent floppy disk, the user will need to reboot the computing device and may therefore lose data that was created and/or modified during the session prior to the lock up.

From the foregoing, it can be appreciated that it would be desirable to have a disk drive that avoids system problems commonly encountered with conventional disk drives.

### SUMMARY OF THE INVENTION

The present disclosure relates to an intelligent disk drive. In one arrangement, the disk drive is configured to be operated by detecting insertion of a disk within the disk drive, reading contents of the disk, and storing a copy of the disk contents in a designated location within memory as a back-up version.

In another arrangement, the disk drive is configured to be operated by detecting a shut down procedure of the computing device, and transmitting an ejection command to the disk drive to cause an ejection mechanism of the disk drive to actuate to eject a floppy disk inserted within the disk drive.

The present disclosure also relates to a computing device. In one arrangement, the computing device comprises a processing device, a disk drive, and memory including a disk back-up controller that is configured to store a copy of contents of a disk inserted into the disk drive in a designated location within memory.

In another arrangement, the computing device comprises a processing device, a disk drive, the disk drive including an ejection mechanism is configured to actuate to automatically eject a disk contained within the disk drive during shut down procedures of the computing device.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an example computing device in which the inventive disk drive can be implemented.

FIG. 2 is a schematic view of an example architecture of the computing device shown in FIG. 1.

FIG. 3 is a flow diagram that illustrates operation of a disk back-up controller shown in FIG. 2.

FIG. 4 is a flow diagram that illustrates operation of a disk ejection controller shown in FIG. 2.

### DETAILED DESCRIPTION

Disclosed is an intelligent disk drive. To facilitate description of the disk drive, an example computing system in which the disk drive can be implemented is described. Although this system is described in detail, it will be appreciated that this system is provided for purposes of illustration only and that various modifications are feasible without departing from the inventive concept. After the example system has been described, examples of operation of the disk drive will be provided to describe its functionality.

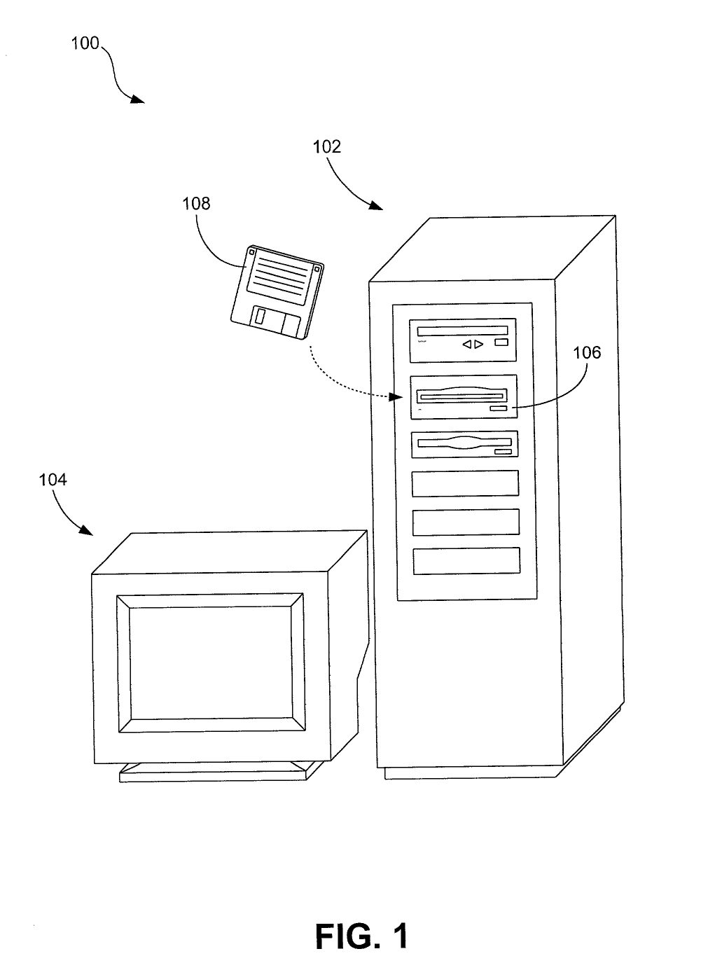

FIG. 1 is a perspective view of an example computing device 100. As indicated in this figure, the computing device 100 can be arranged as a desktop personal computer (PC). Although depicted in this manner, it is to be understood that the computing device 100 can comprise any computing device that includes a disk drive, such as a Macintosh™ computer, notebook computer, etc. Accordingly, the present invention is not limited to implementation with a desktop PC.

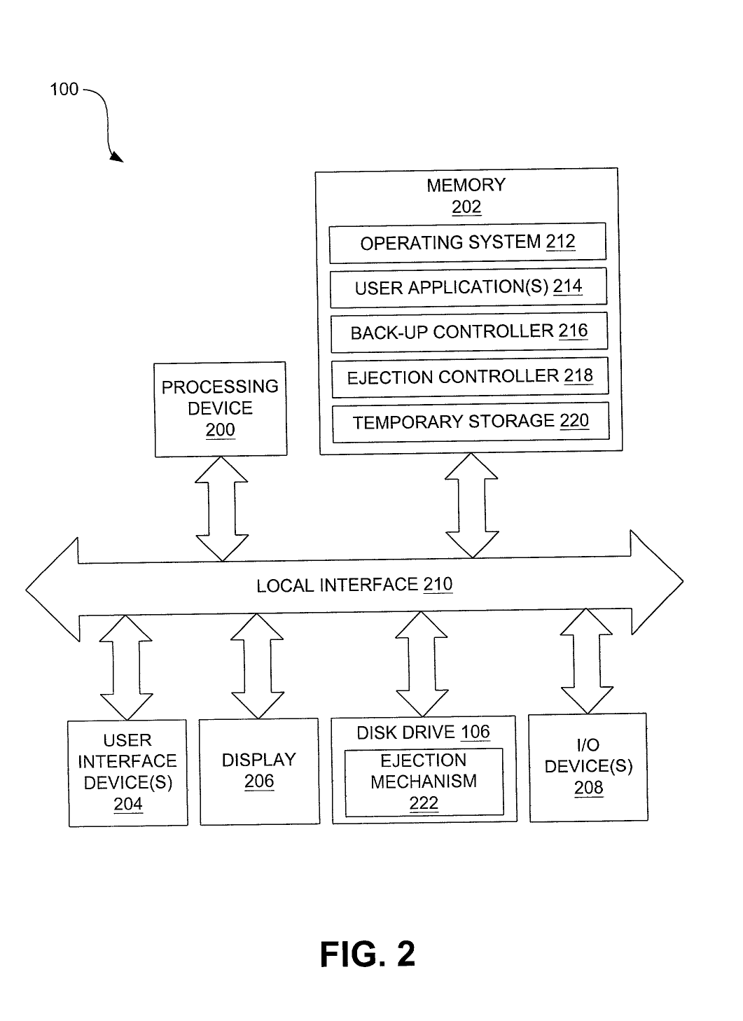

Generally speaking, the computing device 100 can comprise an enclosure (commonly referred to a “box”) 102 and a monitor 104. The enclosure 100 includes the various computing elements, which are described in relation to FIG. 2 below, and houses at least one disk drive 106 that is adapted to receive a floppy disk 108. As indicated in FIG. 1, the enclosure 102 may include other disk drives. Any such drives are, however, beyond the scope of the present disclosure and therefore are not described herein.

FIG. 2 provides an example architecture for the computing device 100 shown in FIG. 1. As indicated in FIG. 2, the computing device 100 can comprise a processing device 200, memory 202, one or more user interface devices 204, a display 206, the disk drive 106, and one or more input/output (I/O) devices 208, each of which is connected to a local interface 210. The processing device 200 can include any custom made or commercially available processor, a central processing unit (CPU) or an auxiliary processor among several processors associated with the computing device 100, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the computing device 100. For example, where the computing device 100 comprises a PC, Macintosh™ computer, or notebook computer, these components can comprise a keyboard, mouse, track ball, or other device commonly used with such computing devices. The display 206 is a device that conveys visual information to the user and can comprise a computer monitor, such as monitor 104 shown in FIG. 1, or a plasma screen where the computing device 100 comprises a notebook computer. The disk drive 106 typically comprises a floppy disk drive that, as identified above, is adapted to receive floppy disks (e.g., floppy disk 108). More particularly, the disk drive 106 typically is adapted to receive, read, and write to the floppy disks. As identified in FIG. 2, the disk drive 106 includes an ejection mechanism 222 that, as is discussed below, is adapted to, upon command, automatically eject any disk inserted within the drive. The mechanism 222 preferably comprises various electromechanical components (e.g., drive motor) which actuate when provided with an appropriate actuation voltage.

With further reference to FIG. 2, the one or more I/O devices 210 are adapted to facilitate connection of the computing device 100 to another device and may therefore include one or more serial, parallel, small computer system interface (SCSI), universal serial bus (USB), IEEE 2294 (e.g., Firewire™), and/or personal area network (PAN) components.

The memory 202 normally comprises an operating system (O/S) 212, one or more user applications 214, a disk back-up controller 216, a disk ejection controller 218, and a temporary storage location 220. The O/S 212 controls the execution of other software and provides scheduling, input-output control, file and data management, memory management, and communication control and related services. The one or more user applications 214 comprise various applications that are accessed by the user to access and/or manipulate data in some manner. By way of example, the applications 214 can comprise a word processing application and a spread sheet application. Normally, the user applications 214 include graphical user interfaces (GUIs) with which the user can interact.

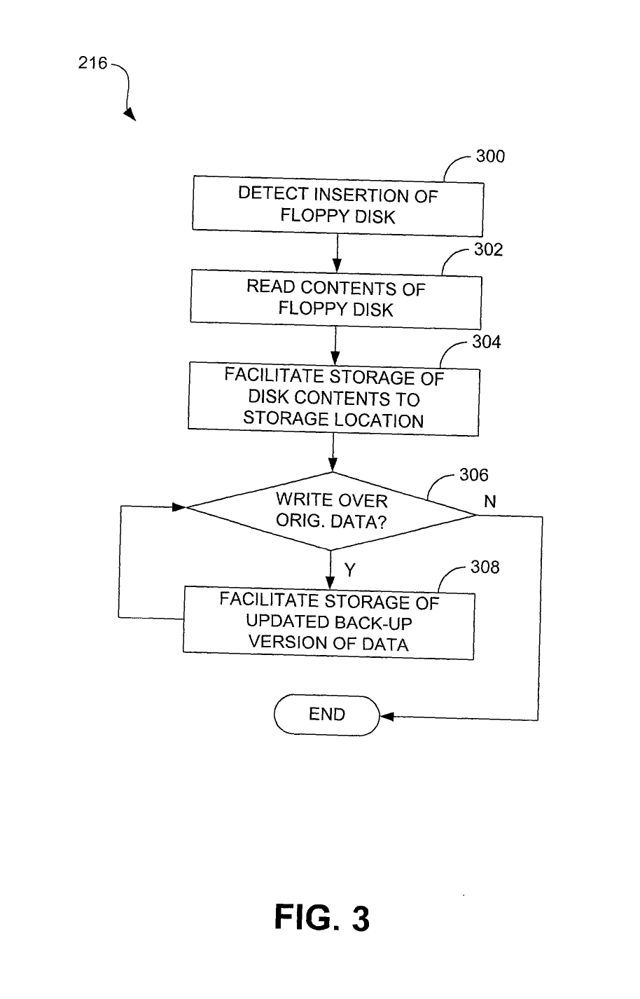

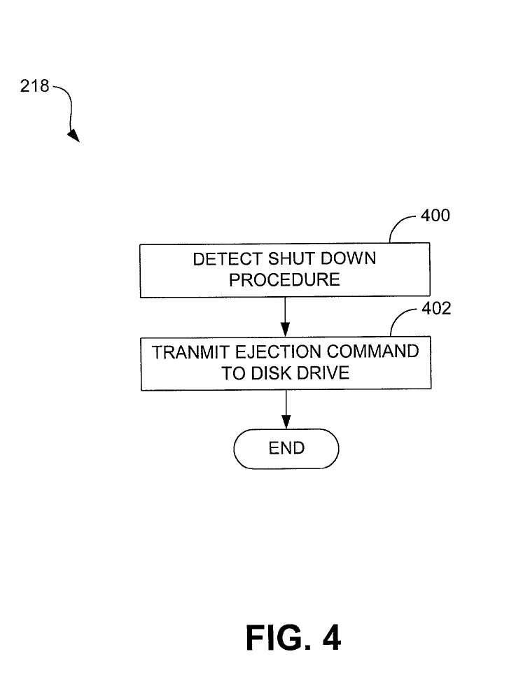

The disk back-up controller 216 comprises software that is configured to automatically store the contents of a disk (e.g., disk 108) inserted into the disk drive 106 as a back-up measure. Operation of the back-up controller 216 is described below with reference to FIG. 3. The disk ejection controller 218 comprises the basic code that is used to activate the ejection mechanism 222 of the disk drive 106 under particular circumstances. Typically, the back-up controller 216 comprises one or more command scripts that form an extension of the operating system 212, or that form part of the underlying computing device basic input/output system (BIOS). The operation of the disk ejection controller 218 is described below with reference to FIG. 4. Finally, the temporary storage location 220 comprises a storage area (repository) within memory 202 that, as is described below, can be used to store disk back-up data. By way of example, the location 220 can comprise a default temporary directory provided by the O/S 212.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example computing device 100 having been described above, operation of the disk drive 106 will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

As discussed above, problems can occur when users attempt to access the source of data after removing a floppy disk that comprises this source. In particular, the computing device 100 may attempt to access the source, discover that the disk is not in the drive, and display an error message or simply lock up. To avoid such problems, it would be advantageous to store a back-up version of the contents of the floppy disk within computing device memory 202. FIG. 3 illustrates a back-up feature of the disk drive 106 which provides for such storage. More particularly, FIG. 3 illustrates operation of the disk back-up controller 216 in controlling the disk drive 106 to ensure that a back-up copy of the floppy disk contents is stored on the computing device 100 so that source access problems such as those noted above can be avoided.

With reference to block 300, the disk back-up controller 216 first detects insertion of a floppy disk into the disk drive 106. Normally, this detection occurs immediately after disk insertion, however, it will be understood that action need not be taken immediately by the back-up controller 216. Once insertion has been detected, the back-up controller 216 reads the contents of the floppy disk (via the drive 106), as indicated in block 302, to determine what programs and/or files are stored thereon. After this reading has been completed, the back-up controller 216 facilitates storage of the disk contents to a predetermined storage location within device memory 202, as indicated in block 304. By way of example, this storage location can comprise the temporary storage location 220 identified above with reference to FIG. 2. Although a particular storage location may be designated by default, it will be appreciated that, if desired, the back-up controller 216 can be configured such that the user is able to designate a preferred storage location. In that the capacity of conventional floppy disks is somewhat limited, this storage process normally can be performed quickly and does not require a large amount of memory space of the computing device 100.

With the back-up version of the disk contents stored in computing device memory 202, problems that typically arise with data source access can be avoided. For instance, if the user opens a file stored on the disk and later removes the disk for some reason (e.g., to open a different file from a different floppy disk), a copy of the file will still be available on the computing device 100 when the user later attempts to access a source for the file. Typically, the back-up version that has been stored by the back-up controller 216 is accessed secondarily. For example, if the user wishes to store a particular disk file in a desired folder on the computing device hard disk (as indicated by an appropriate “save” command), the computing device 100 first attempts to retrieve the source data from the floppy disk. Where the disk has been removed, however, the computing device 100 next attempts to access the source data from storage location used by the back-up controller 216.

Referring now to decision element 306, it can be determined whether the user would like to write over original source data on the disk. For instance, the user may wish to save a new version of an opened disk file after the user has modified the file in some manner (e.g., edited or added to the file). To avoid a situation in which the back-up version stored in the device memory 202 differs from the new version of the file stored on the disk, the back-up controller 216 can be configured to simultaneously write over the back-up version. Accordingly, with reference back to FIG. 3., if the user would like to write over disk source data, flow continues to block 308 at which the back-up controller 216 simultaneously stores an updated version of the back-up data. As noted in FIG. 3, storage of updated back-up versions will continue as long as new versions of data are stored on the disk. Once no more new versions are to be stored, flow is terminated.

As is also discussed above, another problem frequently encountered by disk drive users is interruption of the booting procedure when a disk is inadvertently left in the disk drive. To avoid this problem, the disk drive 106, under control of the disk ejection controller 218, automatically ejects floppy disks from the disk drive upon system shut down. FIG. 4 illustrates an example scenario in which this occurs. Referring to block 400, the ejection controller 218 first detects a computing device shut down procedure. This information can be obtained directly from a shut down or restart command entered by a user (e.g., by accessing the “start” menu) or can be obtained when the shut-down sequence is observed. In the latter case, the ejection controller 218 is configured to recognize the shut down protocol in which the various programs, as well as the O/S, are shut down. Irrespective of the manner of the detection, the ejection controller 218 then transmits a disk ejection command (or voltage) to the ejection mechanism 222 of the disk drive 106, as indicated in block 402, so that the mechanism will actuate to eject the disk from the drive, thereby avoiding later problems with booting of the computing device 100.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for operating a disk drive, comprising the steps of:
detecting insertion of a disk within the disk drive;
reading contents of the disk; and
storing a copy of the disk contents in a designated location within memory as a back-up version.

2. The method of claim 1, further comprising the step of storing a new version of data in the designated location when a user stores a new version of data on the disk.

3. The method of claim 1, further comprising the step of automatically ejecting the disk during a shut down procedure of the computing device.

4. A computing device, comprising:
a processing device;
a disk drive; and
memory including a disk back-up controller that is configured to store a copy of contents of a disk inserted into the disk drive in a designated location within memory.

5. The computing device of claim 4, wherein the disk back-up controller is further configured to store a new version of data in the designated location when a user stores a new version of data on the disk.

6. The computing device of claim 4, further comprising an ejection mechanism that is adapted to automatically eject the disk during a shut down procedure of the computing device.

7. The computing device of claim 4, wherein the disk drive comprises a floppy disk drive.

8. The computing device of claim 4, wherein the computing device is one of a personal computer, a Macintosh computer, and a notebook computer.

9. A method for operating a disk drive, comprising the steps of:
detecting a shut down procedure of the computing device; and
transmitting an ejection command to the disk drive to cause an ejection mechanism of the disk drive to actuate to eject a floppy disk inserted within the disk drive.

10. The method of claim 9, detecting insertion of a disk within the disk drive and storing a copy of the disk contents in a designated location within memory as a back-up version.

11. The method of claim 9, further comprising the step of storing a new version of data in the designated location when a user stores a new version of data on the disk.

12. A computing device, comprising:
a processing device;
a disk drive, the disk drive including an ejection mechanism is configured to actuate to automatically eject a disk contained within the disk drive during shut down procedures of the computing device.

13. The computing device of claim 12, further comprising memory including a disk ejection controller configured to transmit an ejection command to the disk drive when a shut down procedure is detected.

14. The computing device of claim 12, further comprising memory including a disk back-up controller configured to store a copy of disk contents in a designated location within memory as a back-up version when a disk is inserted into the disk drive.

15. The computing device of claim 14, wherein the disk back-up controller is further configured to store a new version of data in the designated location when a user stores a new version of data on the disk.

16. The computing device of claim 12, wherein the disk drive comprises a floppy disk drive.

17. The computing device of claim 12, wherein the computing device is one of a personal computer, a Macintosh computer, and a notebook computer.

18. A disk drive for use in a computing device, the disk drive comprising:
an ejection mechanism configured to automatically eject a disk contained within the disk drive during shut down procedures of the computing device.

19. The disk drive of claim 18, wherein the ejection mechanism comprises electromechanical components that actuate upon application of an appropriate actuation voltage.
